(19) United States
(12) Patent Application Publication
(10) Pub. No.: US 2022/0327424 A1
(43) Pub. Date: Oct. 13, 2022

(54) METHOD AND SYSTEM FOR ONLINE LEARNING FOR MIXTURE OF MULTIVARIATE HAWKES PROCESSES

(71) Applicant: JPMorgan Chase Bank, N.A., New York, NY (US)

(72) Inventors: Mohsen GHASSEMI, Brooklyn, NY (US); Simran LAMBA, Jersey City, NJ (US); Vamsi Krishna POTLURU, New York, NY (US); Sameena SHAH, Scarsdale, NY (US); Manuela VELOSO, New York, NY (US)

(73) Assignee: JPMorgan Chase Bank, N.A., New York, NY (US)

(21) Appl. No.: 17/656,297

(22) Filed: Mar. 24, 2022

Related U.S. Application Data
(60) Provisional application No. 63/166,424, filed on Mar. 26, 2021.

(51) Int. Cl. G06N 20/00; G06F 9/451

(52) U.S. Cl. CPC G06N 20/00; G06F 9/451

(57) ABSTRACT

A method and a system for using an online learning framework for mixture of multivariate Hawkes processes to model sequences of events are provided. The method includes: receiving data that corresponds to a group of event sequences; generating a mixture of multivariate Hawkes processes model based on the group of event sequences; and adjusting the model by applying an online learning algorithm to the generated model. The online learning algorithm includes an E-step that corresponds to updating a set of responsibilities that relates to the group of event sequences and an M-step that corresponds to updating Hawkes processes parameters that relate to the group of event sequences.

### CROSS-REFERENCE TO RELATED APPLICATIONS

This application claims priority from U.S. Provisional Patent Application No. 63/166,424, filed in the U.S. Patent and Trademark Office on Mar. 26, 2021, which is hereby incorporated by reference in its entirety.

### BACKGROUND

### 1. Field of the Disclosure

This technology generally relates to methods and systems for modeling sequences of events, and more particularly to methods and systems for using an online learning framework for mixture of multivariate Hawkes processes to model sequences of events.

### 2. Background Information

Online learning of Hawkes processes has recently received increasing attention, especially for modeling a network of actors. However, these works typically either model the rich interaction between the events or the latent cluster of the actors or the network structure between the actors. We propose to model the latent structure of the network of actors as well as their rich interaction across events for real world settings of medical and financial applications.

In many applications, there is a need to deal with a large number of sequences of events that occur asynchronously and at irregular intervals. Examples of such sequential data include interactions of customers with a bank, customer purchases at a grocery store or an online store, visits of patients to a hospital, and spread of viral diseases such as COVID-19. Each event sequence may consist of multiple events of different types. For example, the visits of a patient to a hospital may be prompted by different health issues and may require attention from doctors with diverse specialties. Predicting the time and the type of the next event for each sequence, finding the possible latent cluster of actors, inferring causal relations between events, and deliberately influencing the behaviors of the actors are some interesting applications when dealing with sequential data.

As a result of the irregular and asynchronous nature of sequential events data, conventional time-series approaches may not be able to capture the rich information that exist in occurrence times of such data. Instead, point processes are commonly used to learn the distribution of sequential event data. In particular, multivariate Hawkes processes (MHP) have received considerable attention in recent years due to their ability to model triggering (or inhibiting) effects of past events of different types on future events. Many works in the literature have focused on employing non-parametric as well as neural network-based approaches to design impact functions that are able to model complex dependencies of events in point processes. Despite the outstanding results, a limitation of such works is that they learn a single dependency pattern for all the sequences of events. To address this shortcoming, the notion of a mixture of multivariate Hawkes processes (MMHP) has been proposed, in order to allow for modeling event sequences where there exist multiple impact patterns across the sequences. The mixture model allows for identifying latent clustering structures across event sequences.

Accordingly, there is a need for using an online learning framework for mixture of multivariate Hawkes processes to model sequences of events, in order to model the latent structure of the network of actors as well as their rich interaction across events for real world settings of medical and financial applications.

### SUMMARY

The present disclosure, through one or more of its various aspects, embodiments, and/or specific features or sub-components, provides, inter alia, various systems, servers, devices, methods, media, programs, and platforms for using an online learning framework for mixture of multivariate Hawkes processes to model sequences of events.

According to an aspect of the present disclosure, a method for modeling sequences of events is provided. The method is implemented by at least one processor. The method includes: receiving, by the at least one processor, data that corresponds to a plurality of event sequences; generating a mixture of multivariate Hawkes processes model based on the plurality of event sequences; and adjusting the model by applying an online learning algorithm to the generated model.

The online learning algorithm may include an expectation step (hereinafter referred to as an “E-step”) that corresponds to updating a plurality of responsibilities that relates to the plurality of event sequences and a maximization step (hereinafter referred to as an “M-step”) that corresponds to updating Hawkes processes parameters that relate to the plurality of event sequences.

The E-step may include maximizing an evidence lower bound function with respect to a set of responsibility parameters that correspond to the plurality of event sequences.

The M-step may include performing a stochastic gradient update on each respective one of a set of intensity parameters and on each respective one of a set of impact functions that correspond to the plurality of event sequences.

The method may further include using the adjusted model to predict, for a particular event sequence from among the plurality of event sequences, a time of a next event and a type of the next event.

The method may further include using the adjusted model to determine, for a particular event sequence from among the plurality of event sequences, a cluster of actors that have performed respective actions within the particular event sequence.

The method may further include using the adjusted model to determine, for a particular event sequence from among the plurality of event sequences, at least one causal relationship between at least two events included in the particular event sequence.

The method may further include displaying, on a display via a graphical user interface (GUI), a result of the adjusting of the model. The GUI may be used to display latent cluster assignments of the actors and to display intensity parameters of the Hawkes processes corresponding to each respective cluster.

The plurality of event sequences may include at least one from among a first event sequence that relates to a banking activity, a second event sequence that relates to a shopping activity, and a third event sequence that relates to a health care activity.

According to another aspect of the present disclosure, a computing apparatus for modeling sequences of events is provided. The computing apparatus includes a processor; a memory; and a communication interface coupled to each of the processor and the memory. The processor is configured to: receive, via the communication interface, data that corresponds to a plurality of event sequences; generate a mixture of multivariate Hawkes processes model based on the plurality of event sequences; and adjust the model by applying an online learning algorithm to the generated model.

The online learning algorithm may include an E-step that corresponds to updating a plurality of responsibilities that relates to the plurality of event sequences and an M-step that corresponds to updating Hawkes processes parameters that relate to the plurality of event sequences.

The E-step may include maximizing an evidence lower bound function with respect to a set of responsibility parameters that correspond to the plurality of event sequences.

The M-step may include performing a stochastic gradient update on each respective one of a set of intensity parameters and on each respective one of a set of impact functions that correspond to the plurality of event sequences.

The processor may be further configured to use the adjusted model to predict, for a particular event sequence from among the plurality of event sequences, a time of a next event and a type of the next event.

The processor may be further configured to use the adjusted model to determine, for a particular event sequence from among the plurality of event sequences, a cluster of actors that have performed respective actions within the particular event sequence.

The processor may be further configured to use the adjusted model to determine, for a particular event sequence from among the plurality of event sequences, at least one causal relationship between at least two events included in the particular event sequence.

The processor may be further configured to display, on a display via a graphical user interface (GUI), a result of the adjusting of the model. The GUI may be used to display latent cluster assignments of the actors and to display intensity parameters of the Hawkes processes corresponding to each respective cluster

The plurality of event sequences may include at least one from among a first event sequence that relates to a banking activity, a second event sequence that relates to a shopping activity, and a third event sequence that relates to a health care activity.

According to yet another aspect of the present disclosure, a non-transitory computer readable storage medium storing instructions for modeling sequences of events is provided. The storage medium includes executable code which, when executed by a processor, causes the processor to: receive data that corresponds to a plurality of event sequences; generate a mixture of multivariate Hawkes processes model based on the plurality of event sequences; and adjust the model by applying an online learning algorithm to the generated model.

The online learning algorithm may include an E-step that corresponds to updating a plurality of responsibilities that relates to the plurality of event sequences and an M-step that corresponds to updating Hawkes processes parameters that relate to the plurality of event sequences.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using an online learning framework for mixture of multivariate Hawkes processes to model sequences of events.

FIG. 4 is a flowchart of an exemplary process for implementing a method for using an online learning framework for mixture of multivariate Hawkes processes to model sequences of events.

FIG. 5 shows an exemplary set of pseudo-code for implementing a method for using an online learning framework for mixture of multivariate Hawkes processes to model sequences of events, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

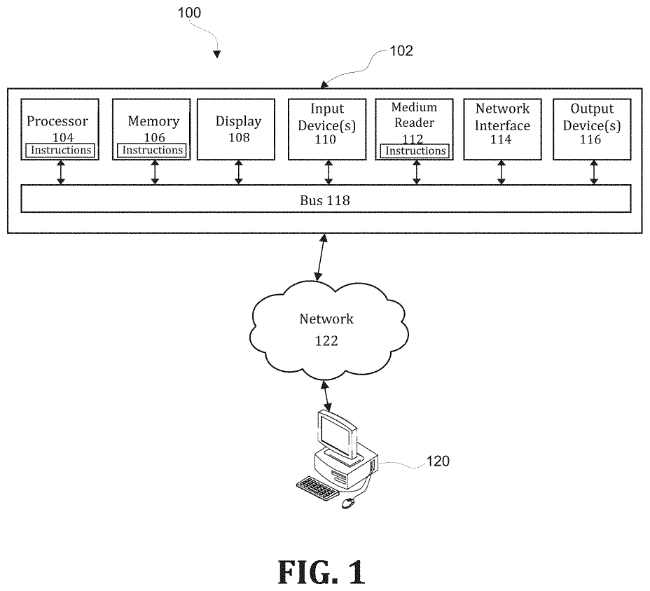

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC).

The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using an online learning framework for mixture of multivariate Hawkes processes to model sequences of events.

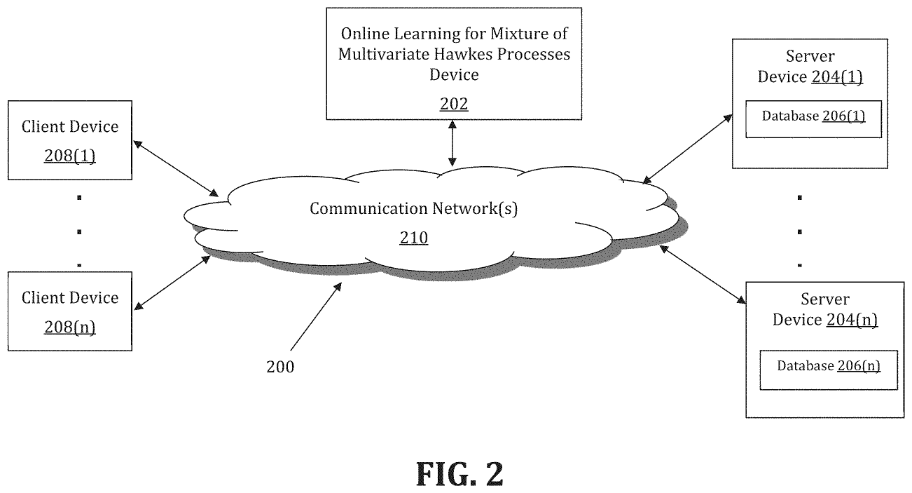

Referring to FIG. 2, a schematic of an exemplary network environment 200 for implementing a method for using an online learning framework for mixture of multivariate Hawkes processes to model sequences of events is illustrated. In an exemplary embodiment, the method is executable on any networked computer platform, such as, for example, a personal computer (PC).

The method for using an online learning framework for mixture of multivariate Hawkes processes to model sequences of events may be implemented by an Online Learning for Mixture of Multivariate Hawkes Processes (OMMHP) device 202. The OMMHP device 202 may be the same or similar to the computer system 102 as described with respect to FIG. 1. The OMMHP device 202 may store one or more applications that can include executable instructions that, when executed by the OMMHP device 202, cause the OMMHP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OMMHP device 202 itself, may be located in virtual server(s) running in a cloud-based computing environment rather than being tied to one or more specific physical network computing devices. Also, the application(s) may be running in one or more virtual machines (VMs) executing on the OMMHP device 202. Additionally, in one or more embodiments of this technology, virtual machine(s) running on the OMMHP device 202 may be managed or supervised by a hypervisor.

In the network environment 200 of FIG. 2, the OMMHP device 202 is coupled to a plurality of server devices 204(1)-204(n) that hosts a plurality of databases 206(1)-206(n), and also to a plurality of client devices 208(1)-208(n) via communication network(s) 210. A communication interface of the OMMHP device 202, such as the network interface 114 of the computer system 102 of FIG. 1, operatively couples and communicates between the OMMHP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OMMHP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OMMHP devices that efficiently implement a method for using an online learning framework for mixture of multivariate Hawkes processes to model sequences of events.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OMMHP device 202 may be a standalone device or integrated with one or more other devices or apparatuses, such as one or more of the server devices 204(1)-204(n), for example. In one particular example, the OMMHP device 202 may include or be hosted by one of the server devices 204(1)-204(n), and other arrangements are also possible. Moreover, one or more of the devices of the OMMHP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OMMHP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to event sequences and data that relates to multivariate Hawkes processes parameters.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OMMHP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OMMHP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OMMHP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OMMHP device 202, the server devices 204(1)-204(n), or the client devices 208(1)-208(n), for example, may be configured to operate as virtual instances on the same physical machine. In other words, one or more of the OMMHP device 202, the server devices 204(1)-204(n), or the client devices 208(1)-208(n) may operate on the same physical device rather than as separate devices communicating through communication network(s) 210. Additionally, there may be more or fewer OMMHP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof

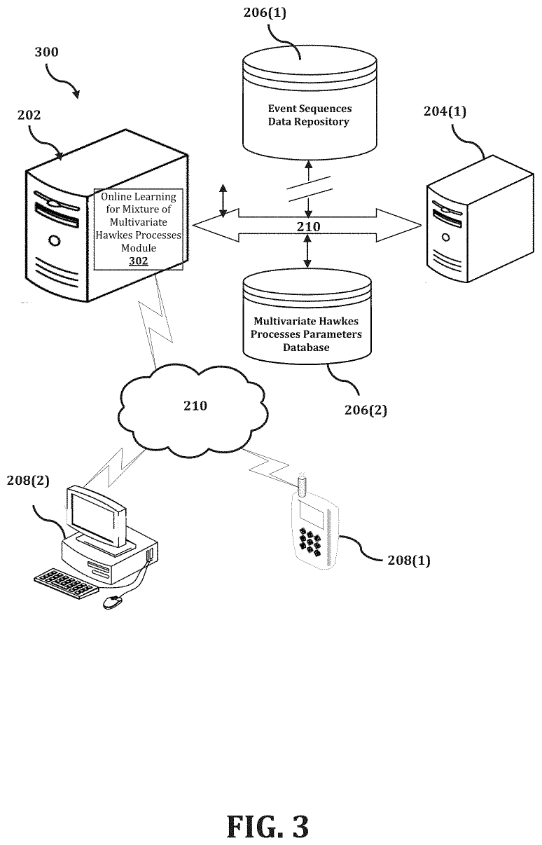

The OMMHP device 202 is described and illustrated in FIG. 3 as including an online learning for mixture of multivariate Hawkes processes module 302, although it may include other rules, policies, modules, databases, or applications, for example. As will be described below, the online learning for mixture of multivariate Hawkes processes module 302 is configured to implement a method for using an online learning framework for mixture of multivariate Hawkes processes to model sequences of events.

An exemplary process 300 for implementing a mechanism for using an online learning framework for mixture of multivariate Hawkes processes to model sequences of events by utilizing the network environment of FIG. 2 is illustrated as being executed in FIG. 3. Specifically, a first client device 208(1) and a second client device 208(2) are illustrated as being in communication with OMMHP device 202. In this regard, the first client device 208(1) and the second client device 208(2) may be “clients” of the OMMHP device 202 and are described herein as such. Nevertheless, it is to be known and understood that the first client device 208(1) and/or the second client device 208(2) need not necessarily be “clients” of the OMMHP device 202, or any entity described in association therewith herein. Any additional or alternative relationship may exist between either or both of the first client device 208(1) and the second client device 208(2) and the OMMHP device 202, or no relationship may exist.

Further, OMMHP device 202 is illustrated as being able to access an event sequences data repository 206(1) and a multivariate Hawkes processes parameters database 206(2). The online learning for mixture of multivariate Hawkes processes module 302 may be configured to access these databases for implementing a method for using an online learning framework for mixture of multivariate Hawkes processes to model sequences of events.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OMMHP device 202 via broadband or cellular communication. Of course, these embodiments are merely exemplary and are not limiting or exhaustive.

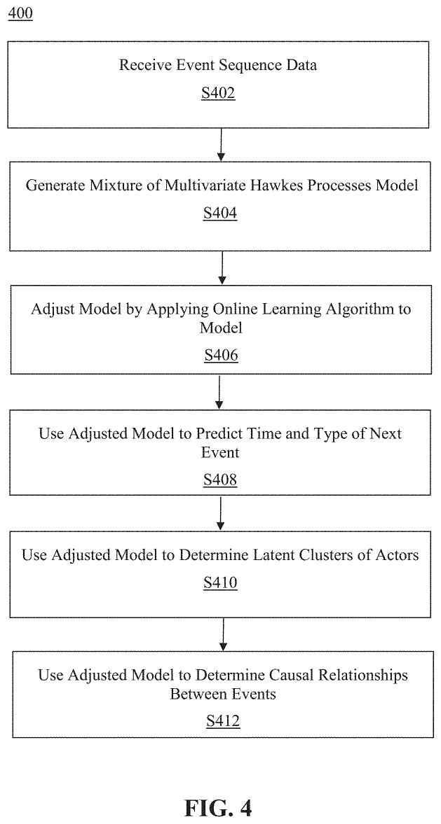

Upon being started, the online learning for mixture of multivariate Hawkes processes module 302 executes a process for using an online learning framework for mixture of multivariate Hawkes processes to model sequences of events. An exemplary process for using an online learning framework for mixture of multivariate Hawkes processes to model sequences of events is generally indicated at flowchart 400 in FIG. 4.

In process 400 of FIG. 4, at step S402, the online learning for mixture of multivariate Hawkes processes module 302 receives data that corresponds to event sequences. In an exemplary embodiment, the event sequences may include at least one from among a first event sequence that relates to a banking activity, a second event sequence that relates to a shopping activity, and a third event sequence that relates to a health care activity. The data may include information that relates to at least one from among a time at which a particular event occurred, a type of a particular event, and/or one or more actors that participated in a particular event.

At step S404, the online learning for mixture of multivariate Hawkes processes module 302 generates a mixture of multivariate Hawkes processes model based on the event sequences to which the data received in step S402 correspond.

At step S406, the online learning for mixture of multivariate Hawkes processes module 302 adjusts the model by applying an online learning algorithm to the model. In an exemplary embodiment, the online learning algorithm includes an expectation step (“E-step”) that corresponds to updating a set of responsibilities that relate to the event sequences and a maximization step (“M-step”) that corresponds to updating Hawkes processes parameters that relate to the event sequences.

In an exemplary embodiment, the E-step includes maximizing an evidence lower bound (ELBO) function with respect to a set of responsibility parameters that correspond to the event sequences. In an exemplary embodiment, the M-step includes performing a stochastic gradient update on each respective intensity parameter and each respective impact function that correspond to the event sequences.

At step S408, the online learning for mixture of multivariate Hawkes processes module 302 uses the adjusted mixture of multivariate Hawkes processes model to predict, for a particular event sequence, a time of a next event and a type of the next event.

At step S410, the online learning for mixture of multivariate Hawkes processes module 302 uses the adjusted mixture of multivariate Hawkes processes model to determine, for a particular event sequence, a latent cluster of actors that have performed respective actions within the particular event sequence.

At step S412, the online learning for mixture of multivariate Hawkes processes module 302 uses the adjusted mixture of multivariate Hawkes processes model to determine, for a particular event sequence, one or more causal relationships between at least two events from within the particular event sequence.

In an exemplary embodiment, the online learning for mixture of multivariate Hawkes processes module 30 may display, on a display via a graphical user interface (GUI), a result of the adjusting of the mixture of multivariate Hawkes processes model. In this manner, a user may be able to better understand and/or visualize the mechanism by which the event sequences are modeled and used for predictions and insights. In an exemplary embodiment, the GUI may also be used to display latent cluster assignments of the actors and to display intensity parameters of the Hawkes processes corresponding to each respective cluster. In this manner, the GUI may illustrate an effective explanation for the clustering of the actors by showing how all of the actors assigned to the same cluster have the same intensity parameters.

The present disclosure describes online learning for mixture of multivariate Hawkes processes (OMMHP). The online learning framework addresses scalability issues of batch models by reducing the per-iteration computational complexity. Moreover, in many applications such as banking, shopping, and health care, streaming sequences of events are often involved. It is often the case that the behaviors of the actors, i.e., the dependencies between events, change over time, possibly abruptly. Similarly, the cluster structures may change over time, with people moving from one cluster to another (e.g., due to a change in employment status) or with new clusters emerging and old clusters disappearing. The drastic changes that many communities are going through due to the recent COVID-19 pandemic emphasizes the dynamic nature of the underlying models of sequential data in many applications. Online learning of MMHP allows for identifying and modeling this dynamic nature without the need for the costly process of training models from scratch.

In an exemplary embodiment, a set of N sequences S={sⁿ}Nₙ₌₁ may be observed in an online manner such that sⁿ={eᵢ=(pᵢ, tᵢ)}Mₙᵢ₌₁ is the set of events, with time-stamp tᵢ and event types pᵢ∈P={1,. . . ,P}, observed thus far. Each sequence corresponds to interactions (i.e., events) of a customer (i.e., actor node) with a product, which indicates an event type. These event sequences may then be modeled by using a mixture of Hawkes processes model. In particular, for type p sequences belonging to a k-th community, the intensity function at time t may be expressed as follows:

$${λ}_{p}^{k} ( t ) = {μ}_{p}^{k} + {\sum }_{i : {t}_{i} < t} {f}^{k} ( t - {t}_{i} ; {θ}_{{p}_{i} p} ) \qquad ( 1 )$$

where μₚ^{k} is the base intensity of the event type p for actors in community k, and f^{k}(t-tᵢ;θ_{pi,p}) is the impact function of event type pᵢ on event type p for actors in community k, parameterized by θ^{k}_{pi,p}. In an exemplary embodiment, the impact functions are exponentials which may be expressed as follows:

f^{k}(t−tᵢ;θ_{pi,p})=a^{k}_{pi,p}exp (−b^{k}_{pi,p}(t−tᵢ)). where θ^{k}ₚᵢₚ=(a^{k}ₚᵢₚ,b^{k}ₚᵢₚ). In an exemplary embodiment, the following definitions may be used: θ^{k}=(θ^{k}ₚ_{ⁱ}ₚ_{^{j}})pᵢ,pⱼ∈[P], μ^{k}=(μₚ^{k})p_{i,pj}∈[P], and Θ={μ^{k},θ^{k}}Kₖ₌₁. Then, the probability of observing a sequence s can be described as

$$P ( s ; Θ ) = {\sum }_{k = 1}^{K} {π}_{k} HP ( s \vert {μ}^{k} , {θ}^{k} ) where \qquad ( 2 )$$

$$HP ( s \vert {μ}^{k} , {θ}^{k} ) = {\prod }_{i : {t}_{i} < T} {λ}_{{p}_{i}}^{k} ( {t}_{i} ) exp ( - {\sum }_{p = 1}^{P} {\int }_{0}^{T} {λ}_{p}^{k} ( s ) ds )$$

and {π^{k}} are the probabilities of the clusters.

Discretized Loss Function: In an exemplary embodiment, the point process may be discretized by partitioning time into intervals of length δ and evaluating the likelihood functions at the end of the intervals. In an exemplary embodiment, the number of events of type p that occurred during the t^{th} time interval may be denoted by X_{t,p}=N_{p,tδ}−N_{p,(t-}1)δ. The conditional likelihood function HP(^{δ}(s|μ^{k},θ^{k}) may then be discretized as follows:

$${HP}^{δ} ( s \vert {μ}^{k} , {θ}^{k} ) = {\prod }_{τ = 1}^{T / δ} {\prod }_{p = 1}^{P} ( {λ}_{p}^{k} ( τδ ) ) \text{?} \cdot exp ( - {\sum }_{τ = 1}^{T / δ} {\sum }_{p = 1}^{P} δ {λ}_{p}^{k} ( τδ ) ) \qquad ( 3 )$$

$$\text{?} \text{indicates text missing or illegible when filed}$$

Consequently, the discretized likelihood function may be expressed as follows:

$${P}^{δ} ( s ; Θ ) {\sum }_{k = 1}^{K} {π}_{k} {\prod }_{τ = 1}^{T / δ} {\prod }_{p = 1}^{P} [ ( {λ}_{p}^{k} ( τδ ) ) \text{?} \cdot exp ( - {δλ}_{p}^{k} ( τδ ) ) ] \qquad ( 4 )$$

$$\text{?} \text{indicates text missing or illegible when filed}$$

Online Learning Algorithm: It is difficult to directly work with the log-likelihood log (Σₖπ^{k}HP^{δ}(s|μ^{k},θ^{k})) due to summation inside the logarithm. Instead, in an exemplary embodiment, the evidence lower bound (ELBO) is defined as

ELBO(Θ)= [symbol] _{q(Z)}[L^{δ}(Θ, Z)]− [symbol] _{q(Z)}[log q(Z)] (5)

for a properly chosen distribution q(Z), where L^{δ}(Θ,Z) is the complete log-likelihood function, which is defined as follows:

$$\begin{matrix}{L}^{δ} ( Θ , Z ) {=}^{Δ} {\sum }_{n = 1}^{N} {\sum }_{k = 1}^{K} \text{?} [ log {π}^{k} + log {HP}^{δ} ( {s}_{n} \vert {μ}^{k} , {θ}^{k} ) ) ] \\ = {\sum }_{τ = 1}^{T / δ} {\sum }_{n = 1}^{N} {\sum }_{p = 1}^{P} {\sum }_{k = 1}^{K} {z}_{nk} [ x \text{?} log ( λ \text{?} ( τδ ) ) - δλ \text{?} ( τδ ) ] + \\ {\sum }_{n = 1}^{N} {\sum }_{k = 1}^{K} {z}_{nk log {π}^{k}} \\ = {\sum }_{τ = 1}^{T / δ} L \text{?} ( Θ , Z ) + {\sum }_{n = 1}^{N} {\sum }_{k = 1}^{K} {z}_{nk log {π}^{k}}\end{matrix}$$

$$\text{?} \text{indicates text missing or illegible when filed}$$

The additive nature of L^{δ}(Θ,Z) allows for adopting online algorithms to maximize the ELBO function. In an exemplary embodiment, it may be assumed that q(Z) takes the simple form q(Z)=Πₙ₌₁^{N}q(zₙ), where q(zₙ)˜multinom(aₙ) and zₙ∈[K]. Therefore,

$$EBLO ( Θ ) = {\sum }_{τ = 1}^{T / δ} {q}_{} ( z ) {L}_{τ}^{δ} ( Θ , Z ) + {\sum }_{n = 1}^{N} {\sum }_{k = 1}^{K} {α}_{nk} log {π}^{k} - {\sum }_{n = 1}^{N} {\sum }_{k = 1}^{K} {α}_{nk} log {α}_{nk} \qquad ( 7 )$$

$$And$$

$${q}_{} ( z ) {L}_{τ}^{δ} ( Θ , Z ) = {\sum }_{n = 1}^{N} {\sum }_{p = 1}^{P} {\sum }_{k = 1}^{K} {α}_{nk} [ {x}_{n , p}^{τ} log ( {λ}_{n , p}^{k} ( τδ ) ) - {δλ}_{n , p}^{k} ( τδ ) ] . \qquad ( 8 )$$

This allows the use of a online variational inference framework for mixture models.

In an exemplary embodiment, the t-th iteration of the online algorithm OMMHP includes the following two steps:

E-Step (responsibilities update): Due to the independence assumption on cluster assignments (q(Z)=Πₙ₋₁^{N}q(zₙ), a coordinate descent procedure may be adopted for updating the responsibilities, i.e., the ELBO function is alternatively maximized with respect to aₙ:

$${α}_{nk}^{t} ∝ {π}^{k} ( t - 1 ) {\underbrace{\begin{matrix}exp & ( {\sum }_{τ = 1}^{t} {\sum }_{p = 1}^{P} [ {x}_{n , p}^{τ} log ( {λ}_{n , p}^{k} ( τδ ) ) - {δλ}_{n , p}^{k} ( τδ ) ] )\end{matrix}}}_{{R}^{t} ( k , n )} \qquad ( 9 )$$

where R^{t}(k,n)=exp(Σₚ₌₁^{p}[x_{n,p}^{t}log(λ_{n,p}^{k}(tδ))−δλ_{n,p}^{k}(tδ)])*R^{t-1}(k,n) may be computed recursively and π^{k}(t−1) is the estimate of π^{k} after observing the (t−1)-th interval (i.e., at the beginning of the t-th interval). It follows trivially that

$${α}_{nk}^{t} = \frac{{π}^{k} ( t - 1 ) {R}^{t} ( k , n )}{{\sum }_{k = 1}^{K} {π}^{k} ( t - 1 ) {R}^{t} ( k , n )} and {π}^{k} ( t ) = {\sum }_{n = 1}^{N} {α}_{nk}^{t} / N .$$

M-Step (Hawkes processes parameters update): In the M-step of OMMHP, a stochastic gradient update is performed on the parameters of the Hawkes processes.

$${μ}_{p}^{k} ( t ) = {μ}_{p}^{k} ( t - 1 ) + {η}_{t} \frac{\partial {{q}^{t - 1} ( z )}_{} {L}_{t}^{δ} ( Θ , Z )}{\partial {μ}_{p}^{k}}$$

$${θ}_{{p}^{i} , {p}^{j}}^{k} ( t ) = {θ}_{{p}^{i} , {p}^{j}}^{k} ( t - 1 ) + {η}_{t} \frac{\partial {{q}^{t - 1} ( z )}_{} {L}_{t}^{δ} ( Θ , Z )}{\partial {θ}_{{p}^{i} , {p}^{j}}^{k}}$$

In particular, the gradient with respect to μₚ^{k} and θₚᵢₚ^{k}=(aₚᵢₚ^{k},bₚᵢₚ^{k}) may be calculated as follows:

$$\frac{\partial {{q}^{t - 1} ( z )}_{} {L}_{t}^{δ} ( Θ , Z )}{\partial {μ}_{p}^{k}} = {\sum }_{n = 1}^{N} {α}_{nk} [ \frac{{x}_{n , p}^{t}}{{λ}_{n , p}^{k} ( t δ )} - δ ]$$

$$\frac{\partial {{q}^{t - 1} ( z )}_{} {L}_{i}^{δ} ( Θ , Z )}{\partial {a}_{{p}_{i} , {p}_{j}}^{k}} = {\sum }_{n = 1}^{N} {α}_{nk} [ \frac{{x}_{n , p}^{t} \text{?}}{{λ}_{n , {p}_{j}}^{k} ( t δ )} - δ ] \sum \text{?} exp ( - {b}^{k} \text{?} ( t δ - t \text{?} ) )$$

$$\frac{\partial {{q}^{t - 1} ( z )}_{} {L}_{t}^{δ} ( Θ , Z )}{\partial {b}_{{p}_{i} , {p}_{j}}^{k}} = {\sum }_{n = 1}^{N} {α}_{nk} [ \frac{{x}_{n , {p}_{j}}^{t}}{{λ}_{n , {p}_{j}}^{k} ( t δ )} - δ ] \sum \text{?} {a}^{k} \text{?} ( {t}_{I} - t δ ) exp ( - {b}^{k} \text{?} ( t δ - t \text{?} ) )$$

$$where$$

$${{p}_{i}}_{t , n}^{} = \{ {e}_{{I}_{n}} = ( {t}_{{I}_{n}} , {p}_{{I}_{n}} ) \vert {t}_{{I}_{n}} \leq t δ , {p}_{{I}_{n}} = {p}_{i} \} .$$

$$\text{?} \text{indicates text missing or illegible when filed}$$

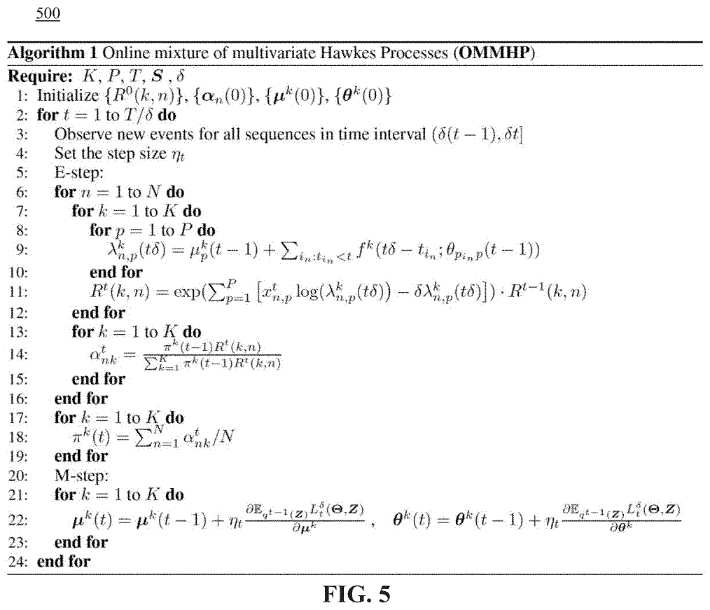

FIG. 5 shows an exemplary set of pseudo-code 500 for implementing an algorithm (referred to herein as Algorithm 1) in a method for using an online learning framework for mixture of multivariate Hawkes processes to model sequences of events, according to an exemplary embodiment.

Detailed Derivation of the Gradient Updates in OMMHP:

The gradient with respect to μₚ^{k}:

$$\begin{matrix}\frac{\partial {{q}^{t - 1} ( z )}_{} {L}_{t}^{δ} ( Θ , Z )}{\partial {μ}_{p}^{k}} = {\sum }_{n = 1}^{N} {α}_{nk} [ {x}_{n , p}^{t} \frac{\partial log ( {λ}_{n , p}^{k} ( t δ ) )}{\partial {μ}_{p}^{k}} - δ \frac{\partial {λ}_{n , p}^{k} ( t δ )}{\partial {μ}_{p}^{k}} ] \\ = {\sum }_{n = 1}^{N} {α}_{nk} [ \frac{{x}_{n , p}^{t}}{{λ}_{n , p}^{k} ( t δ )} - δ ]\end{matrix} \qquad ( 10 )$$

The gradient with respect to a^{k}_{pi,pj}:

$$\begin{matrix}\frac{\partial {{q}^{t - 1} ( z )}_{} {L}_{i}^{δ} ( Θ , Z )}{\partial {a}_{{p}_{i} , {p}_{j}}^{k}} = {\sum }_{n = 1}^{N} {α}_{nk} [ {x}_{n , {p}_{j}}^{t} \frac{\partial log ( {λ}_{n , {p}_{j}}^{k} ( t δ ) )}{\partial {a}_{{p}_{i} , {p}_{j}}^{k}} - δ \frac{\partial {λ}_{n , {p}_{j}}^{k} ( t δ )}{\partial {a}_{{p}_{i} , {p}_{j}}^{k}} ] \\ = {\sum }_{n = 1}^{N} {α}_{nk} [ \frac{{x}_{n , {p}_{j}}^{t}}{{λ}_{n , {p}_{j}}^{k} ( t δ )} - δ ] {\sum }_{I ∈ {{p}_{i}}_{t}^{}} exp ( - {b}_{{p}_{I} , {p}_{j}}^{k} \cdot ( t δ - {t}_{I} ) )\end{matrix} \qquad ( 11 )$$

$$where {{p}_{i}}_{t}^{} = \{ {e}_{I} = ( {t}_{I} , {p}_{I} ) \vert {t}_{I} \leq t δ , {p}_{I} = {p}_{i} \} .$$

The gradient with respect to b^{k}_{pi,pj}:

$$\begin{matrix}\frac{\partial {{q}^{t - 1} ( z )}_{} {L}_{t}^{δ} ( Θ , Z )}{\partial {b}_{{p}_{i} {p}_{j}}^{k}} = {\sum }_{n = 1}^{N} {α}_{nk} [ {x}_{n , {p}_{j}}^{t} \frac{\partial log ( {λ}_{n , {p}_{j}}^{k} ( t δ ) )}{\partial {a}_{{p}_{i} {p}_{j}}^{k}} - δ \frac{\partial {λ}_{n , {p}_{j}}^{k} ( t δ )}{\partial {a}_{{p}_{i} {p}_{j}}^{k}} ] \\ = {\sum }_{n = 1}^{N} {α}_{nk} [ \frac{{x}_{n , {p}_{j}}^{t}}{{λ}_{n , {p}_{j}}^{k} ( t δ )} - δ ] {\sum }_{I ∈ {{p}_{i}}_{t}^{}} {a}_{{p}_{i} {p}_{j}}^{k} \cdot \\ ( {t}_{I} - t δ ) exp ( - {b}_{{p}_{I} , {p}_{j}}^{k} \cdot ( t δ - {t}_{I} ) )\end{matrix} \qquad ( 12 )$$

Accordingly, with this technology, an optimized process for using an online learning framework for mixture of multivariate Hawkes processes to model sequences of events is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for modeling sequences of events, the method being implemented by at least one processor, the method comprising:
receiving, by the at least one processor, data that corresponds to a plurality of event sequences;
generating a mixture of multivariate Hawkes processes model based on the plurality of event sequences; and
adjusting the model by applying an online learning algorithm to the generated model.

2. The method of claim 1, wherein the online learning algorithm comprises an expectation step (E-step) that corresponds to updating a plurality of responsibilities that relates to the plurality of event sequences and a maximization step (M-step) that corresponds to updating Hawkes processes parameters that relate to the plurality of event sequences.

3. The method of claim 2, wherein the E-step comprises maximizing an evidence lower bound function with respect to a set of responsibility parameters that correspond to the plurality of event sequences.

4. The method of claim 3, wherein the M-step comprises performing a stochastic gradient update on each respective one of a set of intensity parameters and on each respective one of a set of impact functions that correspond to the plurality of event sequences.

5. The method of claim 1, further comprising using the adjusted model to predict, for a particular event sequence from among the plurality of event sequences, a time of a next event and a type of the next event.

6. The method of claim 1, further comprising using the adjusted model to determine, for a particular event sequence from among the plurality of event sequences, a cluster of actors that have performed respective actions within the particular event sequence.

7. The method of claim 1, further comprising using the adjusted model to determine, for a particular event sequence from among the plurality of event sequences, at least one causal relationship between at least two events included in the particular event sequence.

8. The method of claim 1, further comprising displaying, on a display via a graphical user interface (GUI), a result of the adjusting of the model.

9. The method of claim 1, wherein the plurality of event sequences includes at least one from among a first event sequence that relates to a banking activity, a second event sequence that relates to a shopping activity, and a third event sequence that relates to a health care activity.

10. A computing apparatus for modeling sequences of events, the computing apparatus comprising:
a processor;
a memory; and
a communication interface coupled to each of the processor and the memory,
wherein the processor is configured to:
receive, via the communication interface, data that corresponds to a plurality of event sequences;
generate a mixture of multivariate Hawkes processes model based on the plurality of event sequences; and
adjust the model by applying an online learning algorithm to the generated model.

11. The computing apparatus of claim 10, wherein the online learning algorithm comprises an expectation step (E-step) that corresponds to updating a plurality of responsibilities that relates to the plurality of event sequences and a maximization step (M-step) that corresponds to updating Hawkes processes parameters that relate to the plurality of event sequences.

12. The computing apparatus of claim 11, wherein the E-step comprises maximizing an evidence lower bound function with respect to a set of responsibility parameters that correspond to the plurality of event sequences.

13. The computing apparatus of claim 12, wherein the M-step comprises performing a stochastic gradient update on each respective one of a set of intensity parameters and on each respective one of a set of impact functions that correspond to the plurality of event sequences.

14. The computing apparatus of claim 10, wherein the processor is further configured to use the adjusted model to predict, for a particular event sequence from among the plurality of event sequences, a time of a next event and a type of the next event.

15. The computing apparatus of claim 10, wherein the processor is further configured to use the adjusted model to determine, for a particular event sequence from among the plurality of event sequences, a cluster of actors that have performed respective actions within the particular event sequence.

16. The computing apparatus of claim 10, wherein the processor is further configured to use the adjusted model to determine, for a particular event sequence from among the plurality of event sequences, at least one causal relationship between at least two events included in the particular event sequence.

17. The computing apparatus of claim 10, wherein the processor is further configured to display, on a display via a graphical user interface (GUI), a result of the adjusting of the model.

18. The computing apparatus of claim 10, wherein the plurality of event sequences includes at least one from among a first event sequence that relates to a banking activity, a second event sequence that relates to a shopping activity, and a third event sequence that relates to a health care activity.

19. A non-transitory computer readable storage medium storing instructions for modeling sequences of events, the storage medium comprising executable code which, when executed by a processor, causes the processor to:
receive data that corresponds to a plurality of event sequences;
generate a mixture of multivariate Hawkes processes model based on the plurality of event sequences; and
adjust the model by applying an online learning algorithm to the generated model.

20. The storage medium of claim 19, wherein the online learning algorithm comprises an expectation step (E-step) that corresponds to updating a plurality of responsibilities that relates to the plurality of event sequences and a maximization step (M-step) that corresponds to updating Hawkes processes parameters that relate to the plurality of event sequences.
